(19) United States
(12) Patent Application Publication
(10) Pub. No.: US 2010/0170775 A1
(43) Pub. Date: Jul. 8, 2010

(54) KEYPAD ASSEMBLY AND MANUFACTURING METHOD THEREOF

(75) Inventors: Joo-Hoon LEE, Yongin-si (KR); Gean-Hyung Kim, Seoul (KR); Se-Jin Kim, Gimhae-si (KR)

Correspondence Address: THE FARRELL LAW FIRM, LLP, 290 Broadhollow Road, Suite 210E, Melville, NY, 11747, US

(73) Assignee: Samsung Electronics Co., Ltd., Suwon-si (KR)

(21) Appl. No.: 12/652,496

(22) Filed: Jan. 5, 2010

(30) Foreign Application Priority Data
Jan. 5, 2009 (KR) 10-2009-0000492

(51) Int. Cl. H01H 13/76; H01H 13/14; H01H 11/00

(52) U.S. Cl. 200/5 A; 200/341; 29/622

(57) ABSTRACT

Disclosed is a keypad assembly and a method for manufacturing the keypad assembly in which a base film member and a button member of the keypad assembly are integrally formed. The keypad assembly includes a base film member, a button member integrally formed with the base film member, and a processed part formed by recessing a space between buttons keys of the button member in a predetermined depth to be spaced apart from the base film member, the processed part being formed on the base film member. The keypad assembly is manufactured such that the button member and the base film member to be recessed between a button key including a pattern of the button member and an adjacent button key in a predetermined depth of the base film member so as to form a processed part. Therefore, the button member can be formed through UV-molding and the press of the button member is simplified.

### PRIORITY

This application claims priority under 35 U.S.C. §119(a) to a Korean Patent Application entitled “Keypad Assembly and Manufacturing Method Thereof” filed in the Korean Industrial Property Office on Jan. 5, 2009 and assigned Serial No. 10-2009-0000492, the contents of which are incorporated herein by reference.

### BACKGROUND OF THE INVENTION

1. Field of the Invention

The present invention relates generally to a keypad assembly and a method for manufacturing a keypad assembly, and more particularly to a keypad assembly and a method for manufacturing the keypad assembly in which a base film member and a button member of a keypad assembly mounted on a mobile electronic device, such as a portable terminal, are integrally formed through the Ultra Violet (UV) molding for flexibility of the keypad assembly.

2. Description of the Related Art

In general, an electronic apparatus such as a portable wireless terminal includes an input device having a keypad serving as a means for sending an input signal.

The two methods for manufacturing input devices, particularly the keypad, are to stamp the keypad at one time, or injection-mold the corresponding numerical or character plates, paint the injection-molded plates, imprint the plates by laser one by one, and attach the numerical plates on a polyurethane base film.

Conventionally, the keypad is designed in a structure in which a dome switch is used to achieve the operation sense in operating the keypad, a silicon-molded protruding portion formed on a lower surface of the polyurethane base film presses the dome switch so as to touch a contact point of a printed circuit board, thereby generating a signal.

A transmission part of the protruding portion and a non-transmission part are divided through a print process employing a screen print, to the polyurethane, the screen-printed sheet is molded with a liquid silicone so as to mold the protruding part, and the keypad is completed when an injection key is painted and laser-imprinted and is attached on the sheet.

FIG. 1 illustrates a conventional keypad assembly. The keypad assembly 10 includes a key button 14, a base film 13, an elastic pad 12, a printed circuit board 15, and a plurality of Light Emitting Diodes (LEDs) 17.

The keypad assembly 10 is sequentially assembled with the key button 14, the base film 13, the elastic pad 12, a protrusion 12a, a switch 16, and the printed circuit board 15.

The base film 13 is made of such materials as polyurethane, Polycarbonate (PC), or Polyethyleneterephthalate (PET). The key button 14 is formed through the UV molding that stably disposes a UV molding liquid on an upper surface of the base film 13 of which the characters, are screen-printed on a lower surface or through attaching with the printed and laser-imprinted injection key. The elastic pad 12 is provided in a lower side of the base film 13 and includes a plurality of protrusions 12a formed on the lower side 12b of the elastic pad 12.

The key buttons 14 are aligned with the corresponding protrusion 12a and the corresponding switch 16 in a direction along the thickness of the keypad assembly 10.

A plurality of grooves 12c are formed on the lower surface 12b of the elastic pad 12. The grooves 12c are arranged on a circumference of the protrusions 12a, respectively, and are formed to escape the interference of the LEDs 17 and the protrusions 12a.

The printed circuit board 15 includes a plurality of switches 16 formed on an upper surface of the printed circuit board 15 that faces the elastic pad 12. Each of the switches 16 includes a conductive contact member 16a and a conductive dome 16b that completely covers the contact member 16a.

The plurality of LEDs 17 are mounted on the upper surface of the printed circuit board 15, and each of the LEDs 17 are placed to be covered by a corresponding groove 12c of the elastic pad 12.

If a user presses any one of the key buttons 14, a part of the elastic pad 14 placed under the key button 14 is deformed toward the printed circuit board 15 so that the corresponding protrusion 12a included in the deformed part presses the corresponding dome 16b. The pressed dome 16b is electrically in contact with the corresponding contact member 16a.

According to the manufacturing process of the keypad assembly 10 including an injection key button, the base film 13 made of polyurethane or a like material is cut, the lower part of the base film 13 is screen-printed, an adhesive is coated on the upper surface of the base film 13 for attaching the key button, the painted and laser-imprinted injection key button is attached on the adhesive, and the key button is attached on the base film 13.

According to the conventional UV molding manufacturing process of the keypad assembly including a UV molded key button, the base film 13 made of the material of PC or PET is cut, the lower part of the base film 13 is screen-printed, the UV molding liquid is stably disposed on the upper surface of the base film 13, and the key button 14 is formed on the base film 13 through the UV molding.

However, such a keypad assembly 10 has the following deficiencies.

If the key button 14 is assembled with a common injection key, the adhesive is coated for attaching the injection key to the base film 13. At this time, if the key button 14 is not opaquely painted, i.e. if the key button 14 is at least partially transparent, the adhesive is seen as a stain.

With the UV molding key, the upper surface of the base film is molded with the UV molding liquid to form the key button, to prevent the contact surface problem caused by the process of attaching the injection key to the base film 13.

However, due to the thickness of the base film and the height of the key button that can be formed through the UV molding, the UV molding key is limited to keypad shape and the flexibility security.

As the base film 13 becomes thin, the difficulty for manufacturing the key button 14 formed on the upper portion of the base film 13 through the UV molding increases, and as the base film 13 thickens, the click sense lessens due to loss of flexibility. Further, when the key button 14 is formed on the upper portion of the base film 13 through the UV molding, the maximum constructible height of the key button 14 is about 0.3 mm, which is a height limitation on the exterior design.

Further, although not depicted in the drawings, at least one waveguide sheet is provided in the lower part of the key button 14 or a functional layer such as an electronic paper is added for additional functions on the keypad. It is necessary to solve both the foregoing problems in the art, so that a more flexible and optically transparent keypad is provided.

Therefore, a demand has been made for the UV molding keypad have an excellent optical property of the contact surface, which will not require the fixing process with the additional adhesive coating. However, it is necessary to develop the keypad assembly of a new structure capable of improving the flexibility of the base film and solving the height limitation of the key button.

### SUMMARY OF THE INVENTION

Accordingly, the present invention has been made to solve the above—stated problems occurring in the prior art, and an object of the present invention is to provide a keypad assembly in which a base film member is integrally mounted with a button member on an upper portion of the base film through UV molding and a method for manufacturing the keypad assembly.

Another object of the present invention is to provide a keypad assembly and a method for manufacturing the keypad assembly in which a button member is integrally disposed on a base film member having a predetermined thickness so as to realize the height of a key button required in the button member formed through UV molding, and also to easily manufacture a UV molding key on an upper portion of the base film member.

Another object of the present invention is to provide a keypad assembly and a method for manufacturing, the keypad assembly in which the space between the UV-molded button members mounted on the upper portion of the base film member is recessed through the numerical control (NC) processing process by a predetermined depth of the base film member so as to minimize the thickness of the space between the UV-molded button members, thereby securing the flexibility on pressing the button member, and to secure the general thickness of the button member, thereby providing flexibility, click sense, and protruding sense of the key button.

Another object of the present invention is to provide a keypad assembly and a method for manufacturing the keypad assembly in which the base film member between the button members and the base film member is recessed through the NC process, even though the base film member and the button member are formed by UV molding, so as to increase flexibility even if an electronic paper or a waveguide sheet is provided in a lower surface of the base film member, and also to optimally secure the light property and flexibility.

In accordance with the present invention, there is provided a keypad assembly includes a base film member, a button member integrally formed with the base film member, and a processed part formed by recessing a space between buttons keys of corresponding button members in a predetermined depth to be spaced apart from a lower surface of the base film member, the processed part being formed on the base film member.

In accordance with the present invention, there is provided a method for manufacturing the keypad assembly includes forming a base film member, of integrally forming a button member with the base film member on an upper surface of the base film member, and processing the base film member to be recessed between button keys of the corresponding button members in a predetermined depth of the base film member so as to form a processed part.

### BRIEF DESCRIPTION OF THE DRAWINGS

The above and other aspects, features and advantages of the present invention will be more apparent from the following detailed description taken in conjunction with the accompanying drawings, in which:

FIG. 1 illustrates a keypad assembly according to the prior art;

FIG. 2 illustrates a keypad assembly according to the present invention;

FIG. 3 illustrates a keypad assembly in which a button member is integrally formed with an upper portion of a UV-molded base film member through UV molding according to the present invention;

FIG. 4 illustrates a keypad assembly in which the space between the button members is recessed in a predetermined depth so as to form a processed part according to the present invention;

FIG. 5 illustrates a keypad assembly in which a frame is disposed on a processed part on an upper surface of the base film member according to the present invention;

FIG. 6 illustrates an uneven part formed on one surface of a waveguide sheet in a keypad assembly according to the present invention; and

FIG. 7 illustrates a method for manufacturing a keypad assembly according to the present invention.

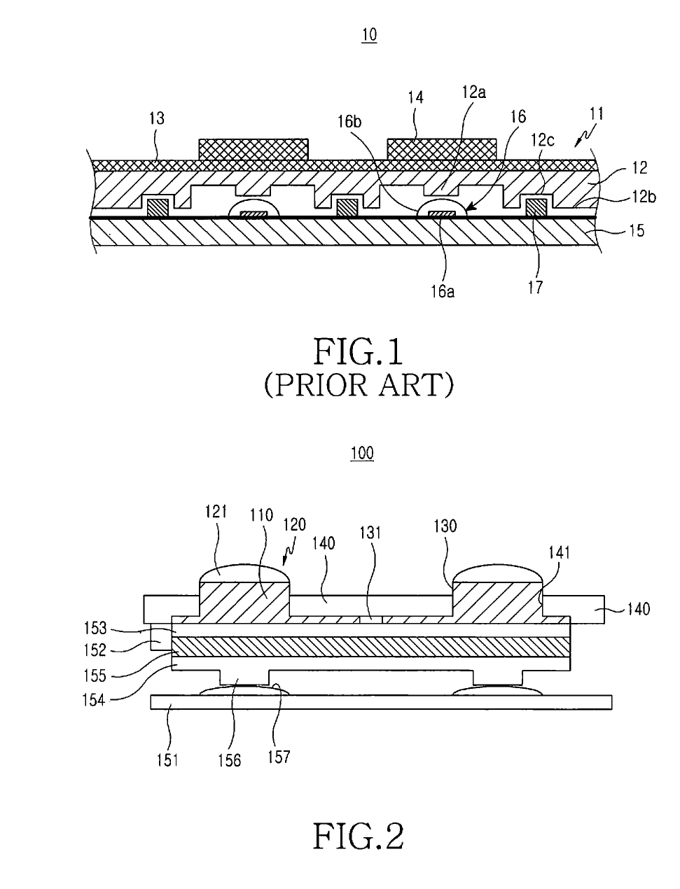

### DETAILED DESCRIPTION OF THE EMBODIMENTS

Hereinafter, the embodiments of the present invention will be described with reference to the accompanying drawings. A description of known parts and functions may be omitted for the sake of clarity and conciseness.

As shown in FIGS. 2, 4, 5, and 6, a keypad assembly 100 according to the present invention includes a base film member 110, a button member 120, and a processed part 130. The button member 120 is integrally formed with the base film member 110 on an upper surface of the base film member 110. The space between the button keys 121 of the button member 120 is recessed in a predetermined depth so as to form the processed part 130 on the base film member 110 being spaced apart from a lower surface of the base film member 110. The button member 120 comprises the button key 121 and the upper portion of the base film member 110 that is upwardly protruded from a flat bottom portion of the base film member 110.

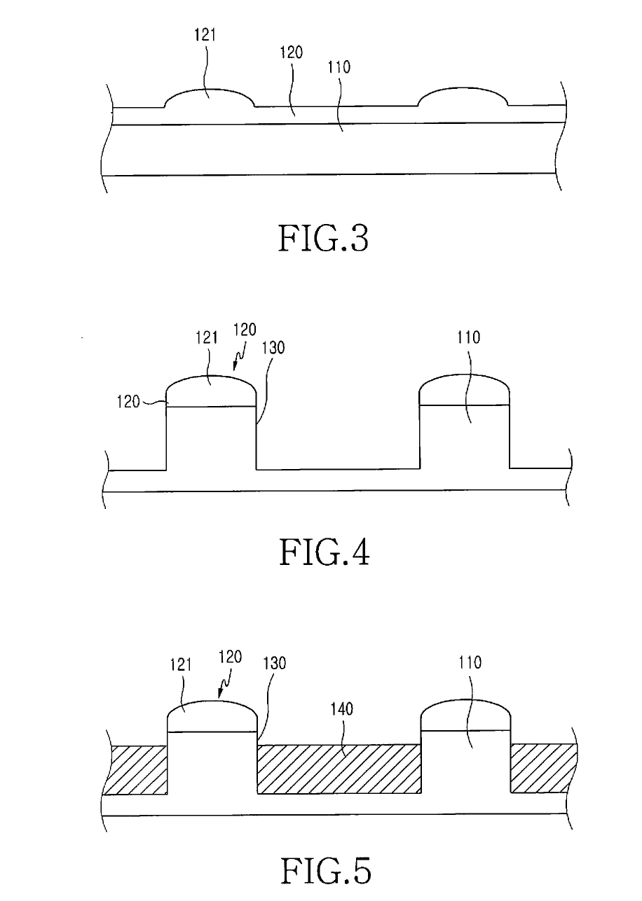

As shown in FIGS. 2, 3, and 4, the base film member 110 is made of at least one of PolyCarbonate (PC) and PolyEthyleneTerephthalate (PET). The button member 120 is integrally formed with a UV molding key 120 on the upper portion of the base film member 110 and the button member 120 includes the button key 121 between the adjacent processed parts 130. Further, the processed part 130 is NC-processed and incised to have a predetermined depth by an NC type machine tool.

As shown in FIGS. 2 to 6, the processed part 130 is a groove that is recessed between the button members 120.

Further, a printed circuit board 151 disposed under the base film member 110 includes a plurality of switches 157 facing the lower surface of the button member 120. A waveguide sheet 153, and an elastic pad 154 are also provided between the printed circuit board 151 and the base film member 110. A light emitting part 152 for emitting light is positioned to face a lateral surface of the waveguide sheet 153. Light emerging from the light emitting part 152 is coupled to the interior of the waveguide sheet 153 via the lateral surface thereof.

The waveguide sheet 153 introduces and progresses the light emitted from the light emitting part 152 so as to emit the light to the button member 120. The elastic pad 154 is disposed on a lower surface of the waveguide sheet 153 and has a protrusion 156 that is formed on a lower surface of the elastic pad 154 and turns on/off the switch 157 according to the press of the button member 120.

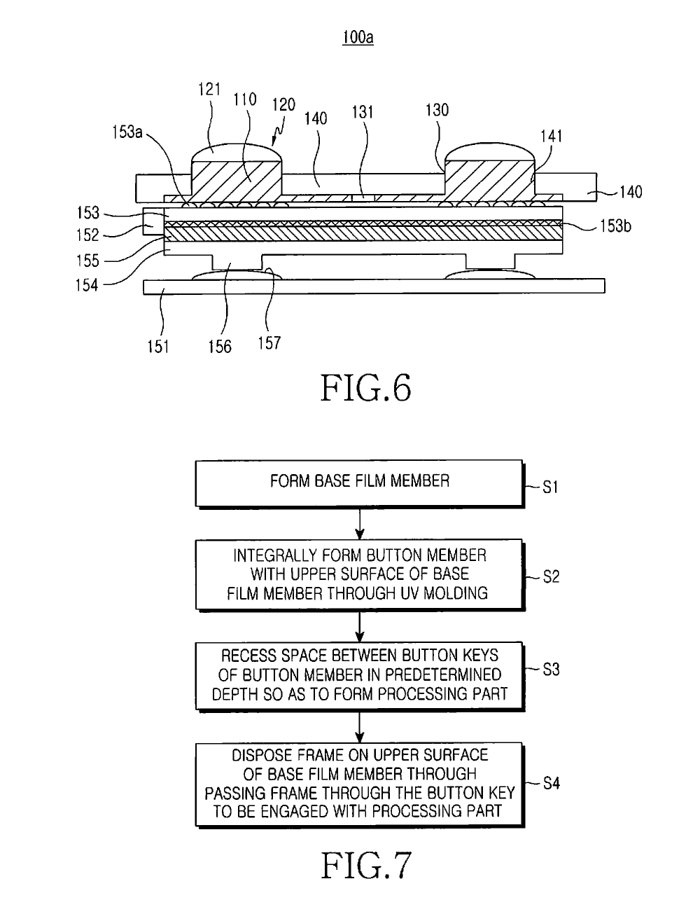

As shown in FIGS. 2 and 6, a display device 155 for displaying a pattern of the button key 121 is further included between the waveguide sheet 153 and the elastic pad 154. The display device 155 may be an electronic paper capable of representing at least one pattern of the button key 121.

As shown in FIG. 6, an upper surface of the waveguide sheet 153 includes a reflective pattern 153a for diffusing the light of the light emitting part 152 and preventing the light interference through maintaining the interval between the waveguide sheet 153 and the base film member 110. The reflective pattern 153a convexly protrudes between the waveguide sheet 153 and the base film member 110. Further, an optical clear adhesive (OCA) 153b is adhered between the waveguide sheet 153 and the display device 155 for attaching the waveguide sheet 153 and the display device 155 and reflecting the light progressed in the waveguide sheet 153 due to a total refection. The OCA 153b transmits the light reflected by the reflective pattern 153a toward the display device 155.

It is preferred that the OCA 153b is made of a material having a lower refractive index than that of the waveguide sheet 153.

The keypad assembly 100a according to the present invention can include either one or both of the reflective pattern 153a and the OCA 153b.

The reflective pattern 153a is a light extracting pattern which extract a portion of the light traveling into the waveguide sheet 153 towards the outside of the waveguide sheet 153 in order to cause the extracted portion of the light to be incident to the display device 155. The reflective pattern 153a reflect the incident light towards the display device 155. The reflective pattern 153a may be formed of at least one V-shape substances, i.e., grooves or prominences-and-depressions whose cross sections that are perpendicular to their longitudinal direction are shaped like V's or a plurality of grooves or prominences-and-depressions shaped like pyramids, on the top surface of the waveguide sheet 153. When the reflective pattern 153a is implemented with the V-shape substances, the V-shape substances may extend from a first lateral surface of the waveguide sheet 153 to a second lateral surface that is on the opposite side of the first lateral surface. The V-shape substances may be sawtooth in shape or may be in a shape that is slightly deformed from the saw tooth shape according to an arbitrary design value.

If necessary, the reflective pattern 153a may be formed of engraved grooves in various shapes or a plurality of embossed protrusions on the top surface of the waveguide sheet 153. For example, the reflective pattern 153a may be formed of a plurality of grooves or a plurality of protrusions, each of which may be in various shapes such as a half circle or a triangular pyramid, or combination thereof. If necessary, reflective pattern 153a may be implemented as a reflection or scattering pattern formed by a scratch or a print.

As illustrated in FIG. 6, each of the reflective patterns 153a is disposed substantially perpendicular below its counterpart button key 121 in order to correspond to the button key 121. The light traveling in the waveguide sheet 153, through total reflection, is incident to the reflective patterns 153a, and most portions of the light reflected or scattered to the display device 155 by the reflective patterns 153a do not meet a total reflection condition in the inner side of the waveguide sheet 153. In this case, the light is irradiated toward the display device 155 after passing through the lower surface of the waveguide sheet 153. The irradiated light is reflected by the display device 155 and then is irradiated outside the waveguide sheet 153 after passing through the waveguide sheet 153. Some portions of the light that travels without being reflected or scattered by the reflective patterns 153a or some portions of the light that is reflected or scattered by the reflective patterns 153a may continue traveling within the waveguide sheet 153 while satisfying the total reflection condition.

If necessary, light extracting patterns may be formed on the lower surface of the waveguide sheet 153. The light extracting patterns refracts a portion of the light traveling into the waveguide sheet 153 towards the outside of the waveguide sheet 153 in order to cause the extracted portion of the light to be incident to the display device 155.

In this case, the light is irradiated toward the display device 155 after passing through the lower surface of the waveguide sheet 153 by the light extracting patterns. The irradiated light is reflected by the display device 155 and then is irradiated outside the waveguide sheet 153 after passing through the waveguide sheet 153.As shown in FIGS. 2, 5, and 6, the base film member 110 further includes a frame 140 on the upper surface thereof, which frame passes through the button member 120 to be disposed on the processed part 130. As shown in FIGS. 2 and 6, the flat bottom portion of the base film member 110 includes a fixing hole 131 for fixing the frame 140. A portion of the frame 140 is inserted in the fixing hole 131.

As shown in FIGS. 2 to 4, the keypad assembly 100 of the present invention includes the base film member 110 made of at least one of PC or PET and the button member 120 formed integrally formed with the base film member 110 on the upper surface of the base film member 110 by UV molding. The button member 120 includes the button key 121 including various patterns, such as characters or numbers.

When the base film member 110 is integrally formed with the button member 120, the processed part 130 is formed between the adjacent button keys 121 and is recessed in the upper surface of the base film member 110 by a predetermined depth through NC-processing. Therefore, the thickness of the processed part 130 can be minimized.

Further, the frame 140 that is passed through by the button member 120, is disposed on the processed part, and improves the aesthetics of the keypad assembly. The frame 140 includes a through hole 141 through which the button member 120 121 pass, respectively.

The frame 140 is disposed on the processed part 130 to prevent the NC-processed part 130 from being exposed and to secure the quality of the exterior shape of the keypad assembly 100, for aesthetic purposes.

The waveguide sheet 153, the electronic paper 155, the elastic pad 154, and the printed circuit board 151 are sequentially provided under the base film member 110.

the light emitting part 152 for emitting light to the button key 121 is positioned on the lateral surface of the waveguide sheet 153 and the waveguide sheet 153 introduces the light emitted from the light emitting part 152 and directs the light toward the inside thereof.

The light emitted from the waveguide sheet 153 is diffused in the upper or lower surface of the button key 121 and is reflected according to the pattern formed on the display device 155 so as to emit the light to the button key 121.

As shown in FIG. 6, the reflective pattern 153a is formed on the waveguide sheet 153 facing toward the button key 121. The reflective pattern 153a is convexly formed in order to diffuse the light emitted from the light emitting part 152 and to maintain the interval between the waveguide sheet 153 and the base film member 110 so as to prevent interference of the light emitted from the light emitting part 152.

Therefore, it is preferred that the reflective pattern 153a prevents interference that can be generated between the base film member 110 and the waveguide sheet 153 and diffuses the light progressing within the waveguide sheet 153, and the light progressing within the waveguide sheet 153 is reflected with the desired pattern of the display device 155, to emit light to the button key 121.

Further, the base film member 110 is made of at least one of PC or PET and the button member 120 is integrally formed with the base film member 110 through UV molding. The prior art has incurred difficulty in forming the button key 121 up to a desired height and the deterioration of the flexibility. However, the space between the adjacent button keys 121 on the upper surface of the base film member 110 is recessed through NC-process by a predetermined depth so as to form the processed part 130, in order to realize the height of the button key 121 and also secure the flexibility on pressing the button key 121.

Therefore, even if the display device 155 is included between the waveguide sheet 153 and the elastic pad 154, the keypad can receive a click sense on pressing the button key 121 and secure the flexibility on pressing the button key.

If the user presses the button key 121 including the desired pattern on the keypad assembly 100 including the above construction, the button key 121 having a predetermined thickness owing to the base film member 110 and integrally formed with the base film member 110 presses the switch 157.

The processed part 130 is a processed groove that is recessed in a predetermined depth through the NC-process in the base film member 110 so as to secure the flexibility due to the thin thickness, thereby being flexibly pressed on pressing the button key 121.

The waveguide sheet 153, the display device 155, and the elastic pad 154 placed at a location of the button member 120 flexibly bent and the protrusion 156 that protrudes from the elastic pad 154 toward the switch 157 and engages with the switch 157 can press the switch 157.

Hereinafter, the method for manufacturing the keypad assembly according to the present invention will be described in detail with reference to the drawings.

As shown in FIG. 7, according to the method for manufacturing the keypad assembly, the base film member 110 made of at least one of PC or PET is formed in step S1.

The button member 120 is integrally formed with the base film member 110 on the upper surface of the base film member 110 through UV molding in step S2.

The space between the adjacent button keys 121 including the patterns of the button members 120 is recessed to have a predetermined depth on one surface of the base film member 110 so as to form the processed part 130 in step S3.

As shown in FIG. 7, the frame 140 that is passed through by the button key 121 and is engaged with the processed part 130 is disposed on the upper surface of the base film member 110 in step S4.

As shown in FIG. 2, the processed part 130 includes the fixing hole 131 for fixing the frame 140 when the frame 140 is disposed.

The printed circuit board 151 including the plurality of switches facing the button key on the lower surface thereof is disposed under the base film member 110, and the waveguide sheet 153, the electronic paper 155 and the elastic pad 154 are sequentially provided between the base film member 110 and the printed circuit board 151. Further, the light emitting part 152 for emitting the light to the button member 120 is disposed on the lateral surface of the waveguide sheet 153.

As shown in FIG. 6, the waveguide sheet 153 facing the button key 120 includes a reflective pattern 153a that convexly protrudes between the waveguide sheet 153 and the base film member 110, to diffuse the light progressing within the waveguide sheet 153 and to prevent interference generated between the waveguide sheet 153 and the base film member 110.

The base film member 110 is made of at least one of PC or PET and the button member 120 is formed through UV molding, and the space between the adjacent button keys 121 on the upper portion of the base film member is NC-processed to be recessed by a predetermined depth so as to secure the flexibility on pressing the button key 121 and to realize the height of the button key 121.

Therefore, even if the display device 155 is provided between the waveguide sheet 153 and the elastic pad 154, the keypad can receive a click sense when the user presses the button member 120 and secure the flexibility on pressing the button member.

As described above, according to the present invention, the UV-molded button member is integrally formed with the base film member on the upper surface of the base film member having a predetermined thickness in order to realize the height of the button key so as to simplify the manufacturing process of the button member and improve the aesthetics of the key button.

Further, the base film member is integrally formed with the button member and the button member between the button keys and the base film member are incised so as to achieve the uniform height of the button key and to minimize the thickness between the button keys, thereby flexibly deforming the button member according to the press of the button key and simplifying the the press of the button key.

Further, the processing hole is formed between the button keys in order to secure the flexibility even if the display device is provided in the keypad assembly, thereby achieving the click sense and maintaining the flexibility when the user presses the button key.

The foregoing are embodiment of the keypad assembly and the method for manufacturing the keypad assembly according to the present invention, and the present invention is not limited thereto. Also, it will be readily understood by those skilled in the art that various modifications and changes can be made thereto within the technical spirit and scope of the present invention. It is also apparent that the modifications and changes fall within the scope of the present invention defined by the appended claims.

What is claimed is:

1. A keypad assembly, comprising:
a base film member;
a button member integrally formed with the base film member; and
a processed part formed by recessing a space between buttons keys of corresponding button members in a predetermined depth to space the button keys apart from a lower surface of the base film member, the processed part being formed on the base film member.

2. The keypad assembly as claimed in claim 1, wherein the base film member is made of at least one of Polycarbonate or Polyethyleneterephthalate.

3. The keypad assembly as claimed in claim 1, wherein the button member is formed through Ultra Violet (UV) molding and the button member includes the button key between corresponding adjacent processed parts.

4. The keypad assembly as claimed in claim 1, wherein the processed part is numerical control (NC) processed to be incised in a predetermined depth.

5. The keypad assembly as claimed in claim 1, wherein the processed part includes a processed groove recessed in a predetermined depth between the button keys.

6. The keypad assembly as claimed in claim 1, further comprising:
a printed circuit board comprising a plurality of switches facing the button key on a lower surface of the base film member;
a light emitting part for emitting light;
a waveguide sheet for introducing and progressing the light emitted from the light emitting part so as to emit the light to the button member; and
an elastic pad having a protrusion turning on/off the switch according to pressing the button member.

7. The keypad assembly as claimed in claim 6, further comprising a display device for representing a pattern of the button key between the waveguide sheet and the elastic pad.

8. The keypad assembly as claimed in claim 7, wherein the display device includes an electronic paper capable of representing at least one patterns of the button key.

9. The keypad assembly as claimed in claim 6, wherein one surface of the waveguide sheet comprises a reflective pattern that diffuses the light of the light emitting part.

10. The keypad assembly as claimed in claim 9, wherein the reflective pattern convexly protrudes between the waveguide sheet and the base film member.

11. The keypad assembly as claimed in claim 6, wherein an optical clear adhesive is adhered between the waveguide sheet and the display device so as to attach the waveguide sheet and the electronic paper.

12. The keypad assembly as claimed in claim 1, further comprising a frame passed through by the button key to be disposed on the processed parts.

13. The keypad assembly as claimed in claim 12, wherein the base film member comprises a fixing hole for fixing the frame.

14. A method for manufacturing a keypad assembly, comprising:
forming a base film member;
integrally forming a button member with the base film member on an upper surface of the base film member; and
processing the base film member to be recessed between button keys of the corresponding button members in a predetermined depth of the base film member so as to form a processed part.

15. The method as claimed in claim 14, further comprising mounting a frame that is passed through by the button member on the upper surface of the base film member to be engaged with the processed part.

16. The method as claimed in claim 15, wherein the processed part comprises a fixing hole for fixing the frame.

17. The method as claimed in claim 14, further comprising:
providing a printed circuit board including a plurality of switches facing the button key;
providing a light emitting part for emitting light;
providing a waveguide sheet for introducing and progressing the light emitted from the light emitting part so as to toward the button member; and
providing an elastic pad formed on a lower surface of the waveguide sheet while facing the switch and including a protrusion turning on/off the switch according to pressing the button member between the base film member and the printed circuit board.

18. The method as claimed in claim 17, wherein an electronic paper for representing at least one of the patterns of the button key is provided between the waveguide sheet and the elastic pad.

19. The method as claimed in claim 17, wherein one surface of the waveguide sheet includes a reflective pattern that diffuses the light of the light emitting part and maintains an interval between the waveguide sheet and the base film member so as to prevent interference.

20. The method as claimed in claim 18, wherein an optical clear adhesive is adhered between the waveguide sheet and the electronic paper so as to attach the waveguide sheet and the electronic paper.
